(19) United States
(12) Patent Application Publication
(10) Pub. No.: US 2005/0153836 A1
(43) Pub. Date: Jul. 14, 2005

(54) Purification catalyst for exhaust gas, production method therefor, and purification catalyst device for exhaust gas

(76) Inventors: Yuichi Matsuo, Wako-shi (JP); Kazunori Kiguchi, Wako-shi (JP); Norihiko Suzuki, Wako-shi (JP); Atsushi Furukawa, Wako-shi (JP)

Correspondence Address: ARENT FOX PLLC, 1050 CONNECTICUT AVENUE, N.W., SUITE 400, WASHINGTON, DC, 20036, US

(21) Appl. No.: 11/032,233

(22) Filed: Jan. 11, 2005

(30) Foreign Application Priority Data
Jan. 13, 2004 (JP) 2004-005523
Jan. 14, 2004 (JP) 2004-006238

(51) Int. Cl. B01J 23/58

(52) U.S. Cl. 502/328

(57) ABSTRACT

A purification catalyst for exhaust gas enhances the activities of noble metals, preventing a drop in activities at high temperatures, and exhibiting a satisfactory performance even in low temperature (below 400° C.) operation when starting up or during idling of automobiles. The Pd-based composite oxide contains at least one element selected from alkaline earth metals.

### BACKGROUND OF THE INVENTION

1. Field of the Invention

The present invention relates to a purification catalyst for exhaust gas, to a production method therefor, and to a purification catalyst device for exhaust gas, and in particular, relates to a technique for a purification catalyst for exhaust gas in which nitrogen oxide (NOx), carbon hydride (HC), and carbon monoxide (CO) contained in an exhaust gas emitted from an internal combustion engine of an automobile or the like during low-temperature operation can be simultaneously and effectively reduced so that the exhaust gas is purified.

2. Related Art

It is known that noble metals (Pt, Rh, Pd, Ir) can purify exhaust gas (for example, CO, HC, NO, NO₂, etc.) at high performance. Therefore, it is suitable to use the above noble metals for a purification catalyst for exhaust gas. Generally, these noble metals are mixed with or supported by Al₂O₃ having high specific surface area with additives such as La, Ce, Nd, etc. In addition, it is known that the noble metal can be combined with various elements by composite oxidation, that various properties are thereby obtained above those of only the noble metal, and therefore, exhaust gas purifying performance can be improved. Furthermore, it is known that the purification catalyst for exhaust gas which is superior in heat resistance can be produced in a solid state or a mixed state of Pd-based composite oxide and transition metal-based composite oxide. Additionally, composite oxides such as perovskite-like oxides which can combine with various elements have extremely varied properties. Therefore, it is preferable that the above composite oxides be used as a purification catalyst for exhaust gas.

As such a purification catalyst for exhaust gas, a heat-resistant catalyst in which coexist Pd-based composite oxide consisting of at least one metal selected from rare earth metal or alkaline earth metal and composite oxide consisting of at least one metal selected from transition metal in a solid treated or mixed state, is proposed (Japanese Unexamined Patent Application Publication No. 10-277393). In the prior art, fine Pd particles are stabilized by using Pd-based composite oxide as a purification catalyst for exhaust gas, and heat-resistance can thereby be improved. In addition, Pd-based composite oxide is prevented from sintering by mixing with transition metal-based composite oxide, and heat-resistance can thereby be improved.

However, in order to produce Pd-based composite oxide in the above prior art, firing at over 1,000° C. is required. Thus, Pd dispersion degree is decreased by progressing crystallization, and there is some fear that superior purifying characteristics cannot be obtained. Therefore, the development technology of a purification catalyst for exhaust gas in which Pd dispersion degree is prevented from decreasing due to progressing crystallization and superior purifying characteristics can be demonstrated, even if composite oxide having a noble metal amount equal to the convention is fired at lower temperature, has been desired.

Additionally, various catalysts mentioned above are now being developed, and for example, a technique in which rate of aggregation of the noble metal is lowered by using perovskite as a supporting material, since noble metal is deteriorated by reducing the active sites, etc., due to aggregation of the noble metal, is disclosed (Japanese Unexamined Patent Application Publication No. 5-86259). In addition, another technique which suppresses reduction of PdO by using a perovskite in which an A site is defective since PdO which is an active species in NO reductive reaction is changed into Pd having low activity by reduction when the noble metal is Pd, is disclosed (Japanese Unexamined Patent Application Publication No. 2003-175337). Furthermore, the noble metals are generally used on supporting materials such as Al₂O₃, etc., either alone or in combination; however, under severe use conditions such as in an automobile, etc., activity is remarkably decreased by decreasing active sites due to aggregation. As a method for solving this problem, use of noble metal which is compositely oxidized with other elements except for noble metal is proposed. In particular, with respect to Pd, composite oxides of rare earth elements and Pd are disclosed (Japanese Unexamined Patent Application Publications Nos. 61-209045, 1-43347, 4-27433, 4-341343, and 7-88372).

However, although conventional purification catalysts for exhaust gas demonstrate sufficient performance which reduce CO, HC, NOx (NO, NO₂, etc.) contained in exhaust gas during high-temperature (over 400° C.) running such as in the running of automobiles, the catalysts cannot demonstrate sufficient performance for reducing CO, HC, and NOx, at start up or during low-temperature (400° C. or less) running such as idling of automobiles.

As mentioned above, the reasons the catalyst cannot demonstrate sufficient performance for purifying the exhaust gas during low temperature running are shown in the following. That is, in the conventional purification catalyst for exhaust gas, noble metals such as Pt, Rh, Pd are supported on Al₂O₃ having high specific surface area. Since Al₂O₃ has high specific surface area, it is advantageous to support the noble metals in a highly dispersed condition. However, activity of the noble metal itself is not improved, since Al₂O₃ is a stable compound and does not interact with the noble metals supported thereon. Therefore, sufficient performance often cannot be obtained during low temperature running.

In addition, it is desirable that Pd exist in a state of PdO having high activity during automobile running. However, even if Pd supported on Al₂O₃ exists in a state of PdO initially, the Pd is reduced to be in a metal state at high temperature (over 900° C.), and there is a problem that active sites decrease by aggregation of Pd and the activity thereby greatly decreases.

### SUMMARY OF THE INVENTION

### 1. First Embodiment

A first embodiment of the present invention was completed in view of the above-mentioned circumstances, and it is an object thereof to provide a purification catalyst for exhaust gas, in which a composite oxide having the same amount of noble metal as in a conventional technique is fired at a lower temperature, and therefore deterioration of Pd dispersion degree by crystallization is prevented and superior purification property is exhibited.

The present inventors researched purification catalysts for exhaust gas and production methods therefor having superior purification properties to realize the above-mentioned object. As a result, the present inventors have discovered that even if the same amount of noble metals as in a conventional technique is used, Pd can exist more around the surface of the catalyst, Pd dispersion can be greatly improved, growth of Pd particles can be restrained, and purification properties can be improved, by using a Pd-based composite oxide containing alkaline earth metals in the purification catalyst for exhaust gas. In addition, by using A₂PdO₃ (A: alkaline earth metal) as a Pd-based composite oxide and by causing multiple Pd-based composite oxides represented by A₂PdO₃ to coexist, elements other than Pd act as a blocking material among each kind of Pd-based composite oxides, the distance between atoms of each Pd-based composite oxide can be maintained to some extent, and initial Pd dispersion and heat resistance can be further improved. Furthermore, in a process of heat treatment of the Pd-based composite oxide, Pd dispersion degree in the Pd-based composite oxide can be maintained at a high level and purification properties can be improved even in the case in which the Pd-based composite oxide is fired at a lower temperature than in a conventional technique. The present invention was completed in view of this knowledge.

The purification catalyst for exhaust gas of the first embodiment of the present invention is characterized in that catalyst is a Pd-based composite oxide containing at least one element selected from alkaline earth metals. Here, the Pd-based composite oxide is defined, for example, as a Pd-based alkaline earth composite oxide A₂PdO₃, and as an A, for example, Sr, Ba or Ca can be selected.

In the purification catalyst for exhaust gas, it is desirable that the above mentioned Pd-based composite oxide be A₂PdO₃.

In addition, in the purification catalyst for exhaust gas, it is desirable that a complex be formed by coexisting organic acid when metal salt which is a raw material is mixed in a solution state. Specifically, in the above purification catalyst for exhaust gas, it is desirable that the Pd-based composite oxide be produced in a process in which at least one kind selected from a group of compounds (carboxylic acid of carbon number 2 to 20 having a OH group or a SH group, dicarboxylic acid of carbon number 2 or 3, or monocarboxylic acid of carbon number 1 to 20) is added to an aqueous nitrate solution of composition element of the Pd-based composite oxide.

As the carboxylic acid having a hydroxyl group or a mercapto group and having a carbon number of 2 to 20, for example, oxycarboxylic acid and a compound in which an oxygen atom in the hydroxyl of the oxycarboxylic acid is substituted with a sulfur atom can be used. The carbon number of these carboxylic acids is 2 to 20 in light of solubility in water, is preferably 2 to 12, is more preferably 2 to 8, and is most preferably 2 to 6. Moreover, the carbon number of the monocarboxylic acid is 1 to 20 in light of solubility in water, is preferably 1 to 12, is more preferably 1 to 8, and is most preferably 1 to 6.

Furthermore, as concrete examples of the carboxylic acids having a hydroxyl group or a mercapto group and having a carbon number of 2 to 20, for example, glycolic acid, mercaptosuccinic acid, thioglycolic acid, lactic acid, β-hydroxy propionic acid, malic acid, tartaric acid, citric acid, isocitric acid, allo-citric acid, gluconic acid, glyoxylic acid, glyceric acid, mandelic acid, tropic acid, benzilic acid, salicylic acid, etc., can be used. As concrete examples of the monocarboxylic acids, for example, formic acid, acetic acid, propionic acid, butyric acid, isobutyric acid, valeric acid, isovaleric acid, hexanoic acid, heptanoic acid, 2-methyl hexanoic acid, octanoic acid, 2-ethyl hexanoic acid, nonanoic acid, decanoic acid, lauric acid, etc., can be used. In the above-mentioned acids, it is preferable to use acetic acid, oxalic acid, malonic acid, glycolic acid, lactic acid, malic acid, tartaric acid, glyoxylic acid, citric acid, and gluconic acid, and it is more preferable to use oxalic acid, malonic acid, glycolic acid, lactic acid, malic acid, tartaric acid, glyoxylic acid, citric acid, and gluconic acid.

Furthermore, such a purification catalyst for exhaust gas is desirably produced by a production method comprising a process for producing carboxylic complex polymer by evaporating and drying the above-mentioned nitrate solution and a process for firing the carboxylic acid complex polymer. As an example of the firing process, a process in which a provisional fired substance is produced by provisional firing in the air so that organic acid and nitrate-nitrogen (nitrate salt and nitrate ion) are removed, and the provisional fired substance is crushed and fired at 750° C. in the air for 10 hours, can be used.

Next, the production method for a purification catalyst for exhaust gas of the present invention is a method which can produce the above purification catalyst for exhaust gas desirably. The production method has at least one compound selected from a group of compounds (carboxylic acid of carbon number 2 to 20, dicarboxylic acid of carbon number 2 or 3, and monocarboxylic acid of carbon number 1 to 20) which is added to aqueous nitrate solution of the composition element of a composite oxide in the production of the purification catalyst for exhaust gas of a Pd-based composite oxide containing at least one element selected from alkaline earth metals.

In such a production method for a purification catalyst for exhaust gas, it is desirable that a process for producing carboxylic acid complex polymer by evaporating and drying the aqueous nitrate solution and a process for firing the carboxylic complex polymer be comprised. Furthermore, it is desirable that the firing temperature in the firing process be 900° C. or less.

The above purification catalyst for exhaust gas and its production method are the basis of the invention; however, the inventors have further researched specific applications of the present invention, and found that the purification catalyst for exhaust gas of the present invention is particularly suited to an internal combustion engine for automobiles, and have thereby completed the following aspect of the present invention.

That is, the purification catalyst device for exhaust gas of automobiles of the present invention includes a Pd-based composite oxide containing at least one element selected from alkaline earth metals, and in that the Pd-based composite oxide purifies exhaust gas from automobiles.

The present invention includes a purification catalyst for exhaust gas including a Pd-based composite oxide, and in the present invention, since alkaline earth metal is added to the Pd-based composite oxide, Pd can exist more around the surface of the catalyst compared to the conventional catalyst, Pd dispersion is greatly improved, and growth of Pd particles can be restrained even in the case in which the same amount of metal is used as in the conventional catalyst. As a result, purification properties can be improved. That is, as shown in FIG. 1, Pd²⁺ is preferably dispersed on supporting material in the Pd-based composite oxide of the present invention. Here, in FIG. 1, A means an alkaline earth metal. In contrast, FIG. 2 shows PdO as a conventional purification catalyst for exhaust gas. In FIG. 2, there are some parts where Pd²⁺ is desirably dispersed; however, Pd partially exists in a metallic state having low reactivity with exhaust gas. Therefore, the present invention is advantageous from the viewpoint that the production technique for purification catalyst for exhaust gas which can efficiently purify and reduce nitrogen oxides (NOx), hydrocarbons (HC), and carbon monoxide (CO) contained in exhaust gas of internal combustion engines of automobiles simultaneously, can be provided. As a nitrogen oxide, NO, NO₂ or the like may be mentioned.

### 2. Second Embodiment

It is an object of a second embodiment of the present invention to provide a purification catalyst for exhaust gas, a production method therefor, and a purification catalyst device for exhaust gas in which activity of the noble metal is improved, and the reduction of activity at high temperatures is prevented, whereby sufficient performance can be obtained even at start up or during idling at low temperatures (below 400° C.) of automobiles.

The present inventors have intensively researched purification catalysts for exhaust gas, in which sufficient performance can be exhibited even at start up or during idling at low temperatures (below 400° C.) of automobiles. As a result, the present inventors have discovered that in the case in which Pd-based composite oxide containing Pd and at least one kind of alkaline earth metal is supported on Al oxide, high activity at a low temperature is obtained. That is, the Pd-based composite oxide is a compound which composes Pd oxide which is unstable at a high temperature and alkaline earth metal oxide which is stable at a high temperature. Thus, in the Pd-based composite oxide, an oxidation state of Pd is stabilized, the oxidation state of Pd in a surface of the compound is a state of Pd²⁺ over a large area, and this state is a preferable state for purifying exhaust gas. Therefore, high activity of purification for exhaust gas can be obtained. In addition, the Pd-based composite oxide has a high heat resistance since it can maintain the state of oxide up to about 1100° C. Furthermore, since the Pd-based composite oxide is a composite compound of alkaline earth element not high in degree of crystallinity and Pd, the produced Pd-based composite oxide is low in degree of crystallinity, and therefore, dispersion of Pd is high. As a result, active sites are increased, and a high purification performance for exhaust gas is obtained.

The present invention was made in view of the above knowledge. That is, the purification catalyst for exhaust gas of the present invention has Pd oxide supported on Al oxide, and the Pd oxide is A₂PdO₃ (A: alkaline earth element).

In addition, in a purification catalyst for exhaust gas in which the Al oxide is perovskite composite oxide represented by LnAlO₃ (Ln is any rare-earth element, including La, Ce, Pr, Nd, Pm, Sm, etc.) and obtained by firing a precursor salt of carboxylic complex polymer, activity during low temperature running after exposure to high temperature can be further improved. That is, in the catalyst of the present invention in which Pd-based composite oxide represented by A₂PdO₃ (A: Alkaline earth element) is supported on Al oxide represented by LnAlO₃, ionic radius of the alkaline earth element included in the Pd-based composite oxide is similar to the ionic radius of the rare earth element included in LnAlO₃. Hence, the contact surfaces of these two composite oxides partly form a solid solution by way of alkaline earth element or rare-earth elements, the mobility of Pd-based composite oxide is reduced, aggregation of Pd-based composite oxide particles is suppressed at a high temperature, and an effect which suppresses decomposition of Pd-based composite oxide to Pd is obtained. Therefore, the catalyst of the present invention, high activity can be maintained even after endurance testing at a high temperature.

The present invention was made in view of the above knowledge. That is, it is desirable that in the above purification catalyst for exhaust gas, the Al oxide be LnAlO₃ (Ln: rare earth element).

Furthermore, the present inventors have also discovered that a LaAlO₃ among LnAlO₃ compounds, is trigonal or rhombohedral form, and a B site in the perovskite is Al in the LaAlO₃, whereby the dipole moment of the LaAlO₃ is large, and an electron fluctuation of Pd-based composite oxide bonded on the LaAlO₃ is larger than that of Pd-based composite oxide which exists independently. Therefore, the oxidation state of Pd in a surface of the Pd-based composite oxide supported is a state of Pd²⁺ over a large area. This state is a preferable state for purifying exhaust gas, whereby high activity at low temperatures can be obtained. Additionally, the present inventors have confirmed that this catalyst can exhibit high activity at low temperatures even after exposing the catalyst to operating conditions of about 1000° C.

In the above purification catalyst for exhaust gas of the present invention, it is preferable that the Al oxide be trigonal or rhombohedral form.

In the producing process of LnAlO₃, the inventors have attempted to produce a carboxylic complex polymer by evaporating and solidifying an aqueous solution of nitrate of constituent elements containing carboxylic acid, and discovered that LnAlO₃ is produced in a single phase, and further that the surface of LnAlO₃ easily interacts with Pd-based composite oxide when the Pd-based composite oxide is supported. As a result, a high activity at low temperature is obtained in the purification catalyst for exhaust gas having Pd-based composite oxide supported on LnAlO₃.

In the above purification catalysts for exhaust gas of the present invention, it is preferable that at least one kind of compound selected from a group of compounds (carboxylic acid having a hydroxyl group or a mercapto group and having a carbon number of 2 to 20, dicarboxylic acid having a carbon number of 2 or 3, and monocarboxylic acid having a carbon number of 1 to 20) be added to an aqueous nitrate solution including a component so that a purification catalyst for exhaust gas is obtained. Moreover, in the purification catalysts for exhaust gas of the present invention, it is preferable that the aqueous nitrate solution be completely evaporated to obtain a carboxylic acid complex polymer and the carboxylic acid complex polymer be fired so that a purification catalyst for exhaust gas is obtained.

As the carboxylic acid having a hydroxyl group or a mercapto group and having a carbon number of 2 to 20, for example, oxycarboxylic acid and a compound in which an oxygen atom in the hydroxyl of the oxycarboxylic acid is substituted with a sulfur atom can be used. The carbon number of these carboxylic acids is 2 to 20 in light of solubility in water, is preferably 2 to 12, is more preferably 2 to 8, and is most preferably 2 to 6. Moreover, the carbon number of the monocarboxylic acid is 1 to 20 in light of solubility in water, is preferably 1 to 12, is more preferably 1 to 8, and is most preferably 1 to 6.

Furthermore, as concrete examples of the carboxylic acids having a hydroxyl group or a mercapto group and having a carbon number of 2 to 20, for example, glycolic acid, mercaptosuccinic acid, thioglycolic acid, lactic acid, β-hydroxy propionic acid, malic acid, tartaric acid, citric acid, isocitric acid, allo-citric acid, gluconic acid, glyoxylic acid, glyceric acid, mandelic acid, tropic acid, benzilic acid, salicylic acid, etc., can be used. As concrete examples of the monocarboxylic acids, for example, formic acid, acetic acid, propionic acid, butyric acid, isobutyric acid, valeric acid, isovaleric acid, hexanoic acid, heptanoic acid, 2-methyl hexanoic acid, octanoic acid, 2-ethyl hexanoic acid, nonanoic acid, decanoic acid, lauric acid, etc., can be used. In the above-mentioned acids, it is preferable to use acetic acid, oxalic acid, malonic acid, glycolic acid, lactic acid, malic acid, tartaric acid, glyoxylic acid, citric acid, and gluconic acid, and it is more preferable to use oxalic acid, malonic acid, glycolic acid, lactic acid, malic acid, tartaric acid, glyoxylic acid, citric acid, and gluconic acid.

Next, a production method for a purification catalyst for exhaust gas of the present invention is a method for preferably producing the above-mentioned catalysts, and is a method for producing the purification catalyst for exhaust gas in which Pd-based composite oxide represented by A₂PdO₃ (A: Alkaline earth element) is supported on Al oxide, includes adding at least one kind of compound selected from a group of compounds (carboxylic acid having a hydroxyl group or a mercapto group and having a carbon number of 2 to 20, a dicarboxylic acid having a carbon number of 2 or 3, and a monocarboxylic acid having a carbon number of 1 to 20) to an aqueous nitrate solution including a component.

In the above-mentioned production method for a purification catalyst for exhaust gas, it is preferable that the aqueous nitrate solution be evaporated completely to obtain a carboxylic acid complex polymer and the carboxylic acid complex polymer be fired, and it is more preferable that the firing temperature be not more than 1000° C.

The above purification catalyst for exhaust gas and its production method are the basis of the invention; however, the inventors have further researched specific applications of the present invention, and found that the purification catalyst for exhaust gas of the present invention is particularly suited to an internal combustion engine for an automobile, and have thereby completed the following aspect of the present invention.

The aspect of the present invention is a purification catalyst for exhaust gas for purifying exhaust gas from an automobile having Pd oxide supported on Al oxide, in which the Pd oxide is A₂PdO₃ (A: Alkaline earth element).

In the case of Pd-based composite oxide containing Pd and at least one alkaline earth element used as the Pd oxide as a constituent element of purification catalyst for exhaust gas of the invention, the effects realized by this composite oxide are explained below.

The Pd-based composite oxide is a composite compound of an unstable Pd oxide and a very stable oxide of alkaline earth element. For example, in the case of PdO, the PdO surface may have two chemical states, Pd⁰ and Pd²⁺. However, in the Pd-based composite oxide, the oxidation state is stabilized by alkaline earth element, and as a result, the chemical state of the compound outer surface is mostly Pd²⁺. Since Pd²⁺ is higher than Pd⁰ in activity, a high purification activity of exhaust gas is obtained in the Pd-based composite oxide.

In addition, the decomposition temperature of PdO is about 800° C.; however, the Pd-based composite oxide is stably present in an oxide state at 1100° C. Therefore, the Pd-based composite oxide has a high heat resistance. That is, Pd, of which the oxide is not stable at high temperature, is compounded with alkaline earth element which is stable in an oxide state, and the Pd—O bond in the bulk is thereby strengthened. The Pd-based composite oxide is a composite compound of alkaline earth element not high in degree of crystallinity and Pd. Hence, the produced Pd-based composite oxide is low in degree of crystallinity, and high in dispersion of Pd. As a result, active sites are increased, and a high purification performance for exhaust gas is obtained. Furthermore, when a composite oxide of alkaline earth element and Pd is supported on Al-based composite oxide composed of LnAlO₃ (Ln: rare-earth element), the ionic radius of alkaline earth elements included in the Pd-based composite oxide is similar to the ionic radius of the rare earth element included in LnAlO₃. Hence, the contact surfaces of these two composite oxides partly form solid solution by way of alkaline earth element or rare-earth elements, the mobility of Pd-based composite oxide is reduced, aggregation of Pd-based composite oxide particles is suppressed at a high temperature, and an effect which suppresses decomposition of Pd-based composite oxide to Pd is obtained. Therefore, in the catalyst of the present invention, high activity can be maintained even after endurance testing at high temperatures.

Next, in the case of Al-based composite oxide (for example, LnAlO₃) containing Al and at least one rare-earth element used as the Al oxide as a constituent element of purification catalyst for exhaust gas of the present invention, the effects realized by this composite oxide are explained below.

The purification catalyst for exhaust gas of the present invention in which Pd-based composite oxide is supported on LnAlO₃ has an effect in which the reduction of Pd-based composite oxide to Pd metal can be suppressed. The shape of Ln (rare-earth metal) variously changes in oxide states. For example, when a catalyst made by supporting Pd on La₂O₃ is exposed to high temperature conditions, La₂O₃ migrates onto the Pd particle from the contact area between Pd and La₂O₃, whereby a shape of filling up La₂O₃ with Pd particles is formed, resulting in additional migration of fine La₂O₃ onto the Pd surface (Zhang et al., J. Phys. Chem., Vol. 100, No. 2, pp. 744-755, 1996). Even in the present system (LnAlO₃), a composite compound of Ln and Pd is formed by the above behavior, whereby reduction of Pd-based composite oxide to Pd metal can be suppressed. Due to this effect, in the purification catalyst for exhaust gas of the present invention, a high activity state can be maintained while running at low temperatures (below 400° C.).

Moreover, in the LnAlO₃, for example LaAlO₃, has a crystal system which is trigonal or rhombohedral form and the B site of perovskite is Al. The trigonal form is a crystal system in which a unit lattice of an ideal cubic system is changed in the c-axis direction and the angle between the a-axis and the b-axis is 120° as shown in FIG. 7. That is, the trigonal form is a crystal system in which an ideal cubic system of a perovskite structure is significantly distorted, and in the crystal system, the electron state among constituent atoms is extremely unstable. The rhombohedral form is a crystal system which exhibits the trigonal form by a different basic axis, and the structure itself is the same as in the trigonal form as shown in FIG. 8. FIG. 9 is an XRD spectrum as data demonstrating the difference in crystal systems of LaAl₃ supporting Pd-based composite oxide. That is, comparing the structures of LaAlO₃, NdAlO₃, and GdAlO₃, as can be seen from the diagram, the crystal systems of LaAlO₃ and NdAlO₃ are trigonal or rhombohedral form, while the crystal system of GdAlO₃ is neither trigonal nor rhombohedral form, but is orthorhombic form.

In the LaAlO₃ and NdAlO₃, a B site in the perovskite is Al, whereby the bond between Al and O has a high degree of probability of being a covalent bond. Therefore, some of the dipole moment is generated in a crystal of perovskite which has generally a high degree of probability of being an ionic bond. As described above, the crystal systems are trigonal or rhombohedral form, and a B site in the perovskite-like composite oxides is Al in the oxides, whereby the perovskite which is LaAlO₃ and NdAlO₃ has larger dipole moment of the oxides than that of the well-known purification catalyst for exhaust gas, for example LaFeO₃.

Due to the dipole moment, an electron fluctuation of Pd-based composite oxide bound on the LaAlO₃ or NdAlO₃ is larger than that of Pd-based composite oxide which exists independently. As a result, the oxidation state of Pd in a surface of the Pd-based composite oxide supported is a state of Pd²⁺ over a large area. There are two oxidation states of Pd in a surface of the Pd-based composite oxide, which are a state of Pd²⁺ and a state of Pd₀ (metal state), and activity of purification for exhaust gas of the state of Pd²⁺ is higher than that of Pd⁰. That is, in the purification catalysts for exhaust gas of the present invention in which Pd-based composite oxide is supported on the LaAO₃ or NdAlO₃, the oxidation state of Pd in a surface of the PdO is the state of Pd²⁺, whereby the catalysts of the present invention have high activity. Moreover, the catalysts of the present invention can exhibit high activity during running at low temperatures (below 400° C.) even after exposing the catalyst to an operating condition of about 1000° C.

Furthermore, when the LaAlO₃ or NdAlO₃ is produced, an aqueous nitrate solution of a component containing carboxylic acid, etc., is completely evaporated to obtain a carboxylic acid complex polymer, and the polymer is fired at a relatively low temperature of 800° C., whereby LaAO₃ or NdAlO₃ are generated as a single phase. In contrast, when the LaAO₃ or the like is produced in other ways, for example, solid-phase reaction, LaAO₃ or the like is not generated as a single phase even if it is fired at a relatively high temperature of 1700° C. (see Rare Earth Science, Kagaku-Dojin Publishing Company, Inc, Ginya Adachi, p. 564). That is, LaAlO₃ or the like of the single phase can be synthesized at the above-mentioned low temperature by using carboxylic acid, etc. Therefore, sufficient specific surface area can be obtained, and the catalyst can be used in a state in which the surface of the crystal lattice is active. In the purification catalyst for exhaust gas made by supporting Pd-based composite oxide on the LnAlO₃ or the like using the method of the present invention, sufficient specific surface area and strong interaction between LnAlO₃ or the like and Pd-based composite oxide can be obtained, whereby high activity at low temperatures can be realized.

### BRIEF DESCRIPTION OF THE DRAWINGS

FIG. 1 is a schematic showing the Pd dispersion state of Pd-based composite oxide which constitutes a purification catalyst for exhaust gas of the present invention.

FIG. 2 is a schematic showing the Pd dispersion state of Pd-based composite oxide which constitutes a conventional purification catalyst for exhaust gas.

FIG. 3 is a graph showing the relationship between purification rate of CO and temperature on each purification catalyst for exhaust gas of Production Examples 1 to 4, and FIG. 3A shows temperature increase characteristics of a catalyst before endurance running and FIG. 3B shows temperature increase characteristics of a catalyst after endurance running.

FIG. 4 is a graph showing the relationship between purification rate of HC and temperature on each purification catalyst for exhaust gas of Production Examples 1 to 4, and FIG. 4A shows temperature increase characteristics of a catalyst before endurance running and FIG. 4B shows temperature increase characteristics of a catalyst after endurance running.

FIG. 5 is a graph showing the relationship between purification rate of NO and temperature on each purification catalyst for exhaust gas of Production Examples 1 to 4, and FIG. 5A shows temperature increase characteristics of a catalyst before endurance running and FIG. 5B shows temperature increase characteristics of a catalyst after endurance running.

FIG. 6 is a graph showing Pd dispersion degree on each purification catalyst for exhaust gas of Producing Examples 1 to 4.

FIG. 7 is a perspective view showing an example of crystal system (trigonal from) of Al oxide composing a purification catalyst for exhaust gas of the present invention.

FIG. 8 is a perspective view showing an example of crystal system (rhombohedral form) of Al oxide composing a purification catalyst for exhaust gas of the present invention.

FIG. 9 is an XRD spectrum showing differences in crystal systems of various Al oxides on which Pd-based composite oxides are supported.

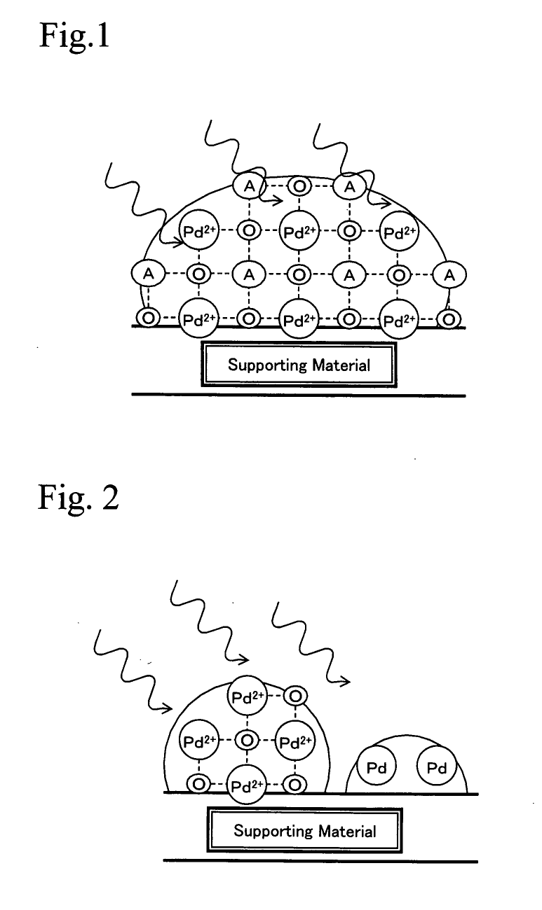

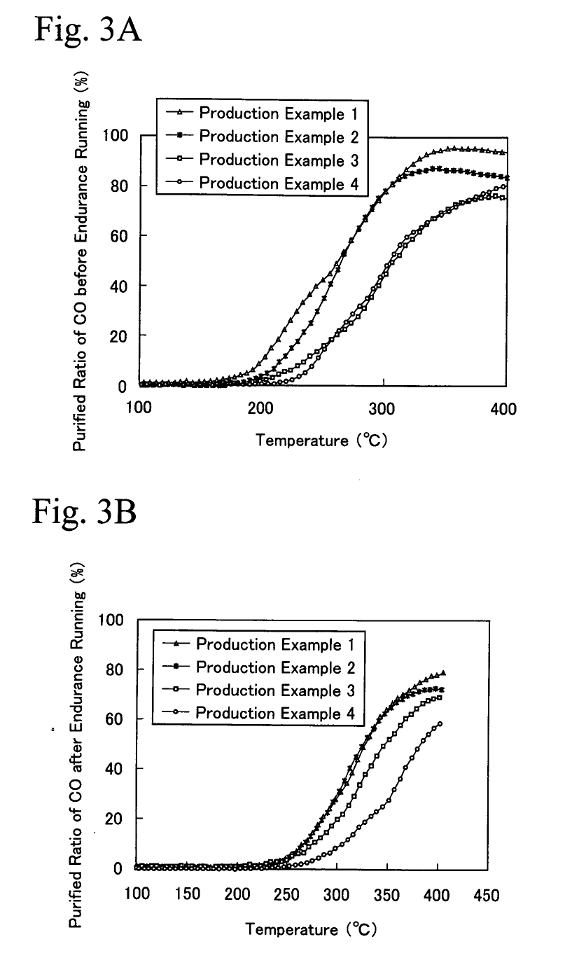

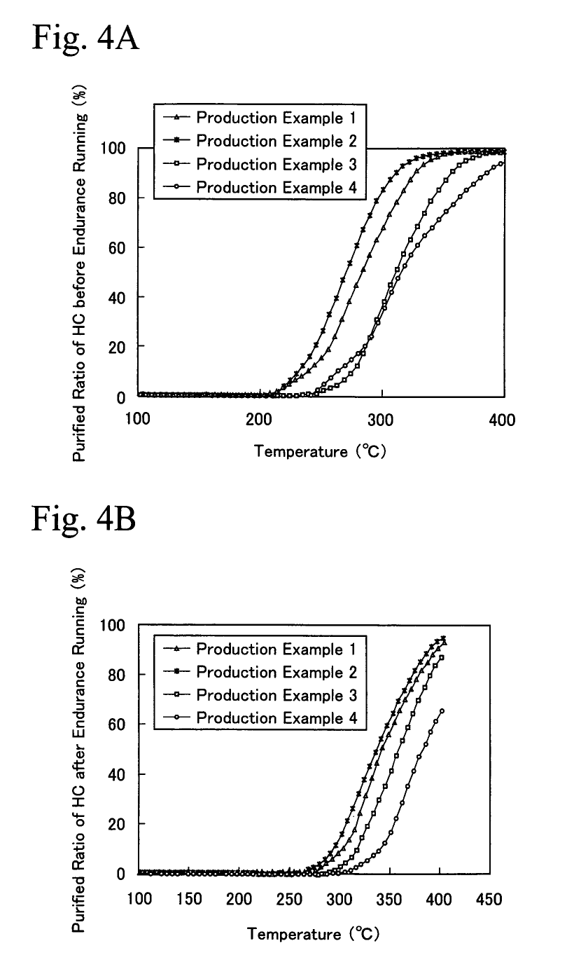

### DETAILED DESCRIPTION OF THE INVENTION

In the following, the present invention will be explained in detail by embodiments.

### 1. First Embodiment

### Production Example 1

A mixed metal nitrate aqueous solution was produced by dissolving 2.96 g (0.014 mol) of strontium nitrate, 1.86 g (0.007 mol) of palladium nitrate, and 3.75 g (0.028 mol) of malic acid in 100 ml of ion exchanged water. Next, the mixed metal nitrate aqueous solution was evaporated and dried at 250° C. while stirring with a stirrer on a hot plate. Subsequently, the dried sample was moved in an alumina crucible, and it was heated to 350° C. at a rate of 2.5° C./min in a muffle furnace and was heat-treated at 350° C. for 3 hours. A provisional fired substance in which nitrate-nitrogen (nitrate salt and nitrate ion) was removed was thereby produced.

The provisional fired substance was crushed into powder by a mortar for 15 minutes, and then was moved to an alumina crucible again, was heated to 750° C. at a rate of 5° C./min in a muffle furnace and was retained at 750° C. for 10 hours, and firing was thereby carried out. Next, catalyst powder which was Pd-based composite oxide, water, ball for crushing, SiO₂ sol, and alumina were put into a container, and was crushed and mixed by a ball mill for 14 hours, and a slurry was thereby obtained. Subsequently, the slurry was retained at 750° C. for 3 hours after supporting in a honeycomb at a predetermined weight. Thus, a purification catalyst for exhaust gas of Sr₂PdO₃ was produced.

### Production Example 2

Barium nitrate was used instead of the strontium nitrate used in the above Production Example 1, and a purification catalyst for exhaust gas of Ba₂PdO₃ was produced. The other conditions were the same as those of Production Example 1.

### Production Example 3

A purification catalyst for exhaust gas of PdO was produced in the same manner as those of Production Example 1, except for using a nitrate aqueous solution mixing metal in which palladium nitrate and malic acid were dissolved in ion exchanged water.

### Production Example 4

A mixed aqueous solution of palladium nitrate and strontium nitrate was neutralized by ammonium carbonate and was concentrated, and a mixture in a paste state was obtained. Next, it was thermally decomposed at 300° C. and was fired at 1000° C. for 3 hours, and Sr₂PdO₃ powder was obtained. The powder was crushed, was mixed with alumina in the same manner as that of Production Example 1, and was supported on a honeycomb at a predetermined weight, and a purification catalyst for exhaust gas of Sr₂PdO₃ was produced. In connection with each purification catalyst for exhaust gas produced as above, active evaluations before and after endurance running were carried out. The active evaluation before endurance running was carried out by repeatedly circulating model exhaust gas in which air-fuel ratio was substantially 14.3 and 14.9 to each catalyst in a 0.5 second cycle (one cycle is 1 Hz), at flow amount per unit time and unit volume of 50000 h⁻¹, and at a reaction temperature between 30 to 400° C. The endurance running was carried out by using model exhaust gas in which air-fuel ratio was substantially 14.6 at a gas temperature of 900° C. for 20 hours. The evaluation after endurance running was carried under such condition. Temperature rising test conditions are shown in Table 1 and results of the each active evaluation are shown in Tables 2 and 3. That is, 50% purification temperature of CO, HC, and NO and purification rate at 400° C. in the temperature rising test of the catalyst before endurance running are shown in Table 2. In addition, 50% purification temperature of CO, HC, and NO and purification rate at 400° C. in the temperature rising test of the catalyst after endurance running are shown in Table 3.

TABLE 1

| | |
|---|---|
| Catalyst Volume | 60 cc |
| Reaction Temperature | 30˜400° C. |
| Temperature Increase Rate | 30° C./min |
| Flow Amount | 25 L/min |
| Lean-Rich Changing Time | 0.5 sec |

| Reaction Gas | Lean | Rich |
|---|---|---|
| CO | 0.34% | 0.86% |
| H₂ | 0.11% | 0.28% |
| CO₂ | 14% | 14% |
| HC | 1200 ppm | 1200 ppm |
| O₂ | 0.69% | 0.38% |
| NOₓ | 500 ppm | 500 ppm |
| H₂O | 10% | 10% |

TABLE 2

| | 50% Purification | | | 400° C. Purified | | |
|---|---|---|---|---|---|---|
| | Temperature (° C.) | | | Ratio (%) | | |
| | CO | HC | NO | CO | HC | NO |
| Production | 283 | 290 | 231 | 78.3 | 98.6 | 69.6 |
| Example 1 | | | | | | |
| Production | 262 | 283 | 234 | 93.5 | 99.0 | 80.0 |
| Example 2 | | | | | | |
| Production | 303 | 315 | >400 | 80.7 | 94.6 | 49.1 |
| Example 3 | | | | | | |
| Production | 308 | 310 | 324 | 76.1 | 98.4 | 63.8 |
| Example 4 | | | | | | |

TABLE 3

| | 50% Purification | | | 400° C. Purified | | |
|---|---|---|---|---|---|---|
| | Temperature (° C.) | | | Ratio (%) | | |
| | CO | HC | NO | CO | HC | NO |
| Production | 325 | 336 | 384 | 72.5 | 94.8 | 54.3 |
| Example 1 | | | | | | |
| Production | 327 | 342 | 401 | 78.1 | 91.0 | 49.8 |
| Example 2 | | | | | | |
| Production | 382 | 382 | >400 | 58.0 | 64.8 | 24.3 |
| Example 3 | | | | | | |
| Production | 345 | 358 | >400 | 69.0 | 87.1 | 40.6 |
| Example 4 | | | | | | |

According to Tables 2 and 3, in the purification catalysts for exhaust gas of Production Examples 1 and 2 which are within the range of the present invention, it was shown that 50% purification temperatures before and after endurance running were relatively low and 400° C. purification rates therein also have high value. In contrast, in purification catalysts for exhaust gas of Production Examples 3 and 4 which are outside the range of the present invention, it was shown that 50% purification temperatures before and after endurance running were relatively high and 400° C. purification rates therein also had low values.

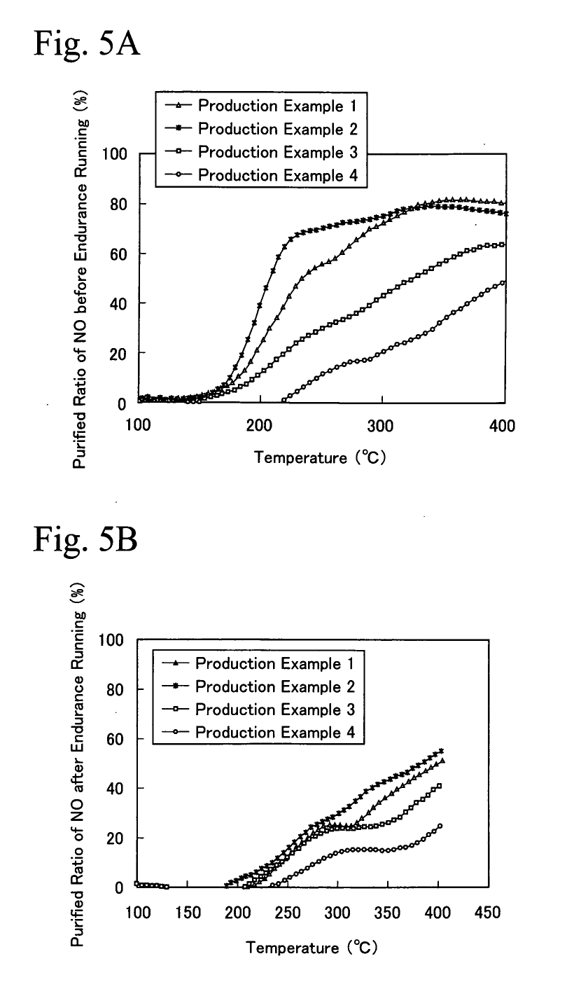

Next, FIGS. 3 and 5 show the relationship between each purification rate and temperature of CO, HC, and NO on each purification catalyst for exhaust gas of Production Examples 1 to 4. In these figures, A shows temperature increase characteristics of the catalyst before endurance running and B shows temperature increase characteristics of the catalyst after endurance running. As is apparent from these figures, it was shown that purification characteristics of the purification catalysts for exhaust gas of Production Examples 1 and 2 which are within the range of the present invention were superior over about 200° C. to that of the purification catalysts for exhaust gas of Production Examples 3 and 4 which are outside the range of the present invention.

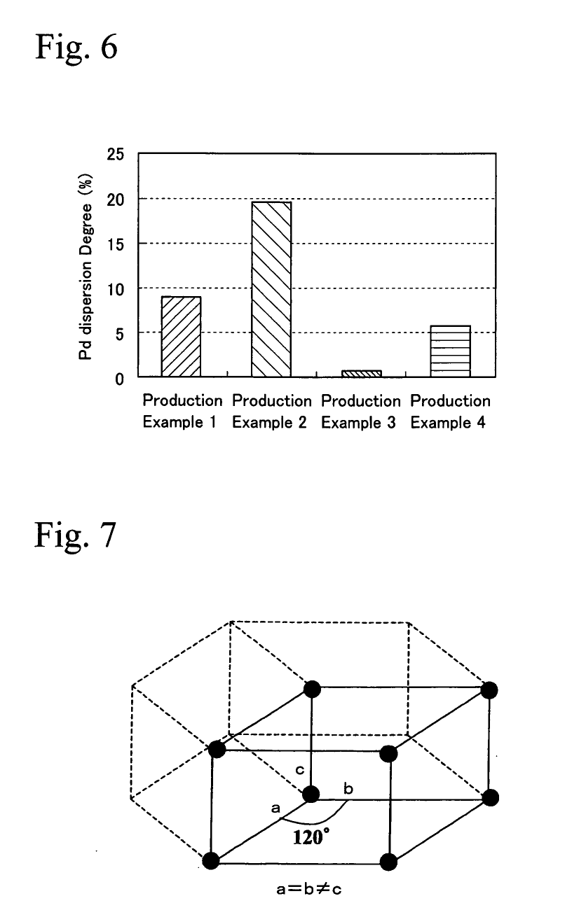

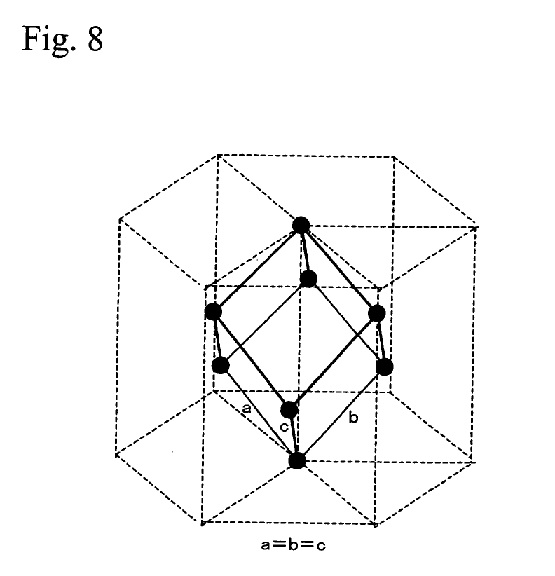

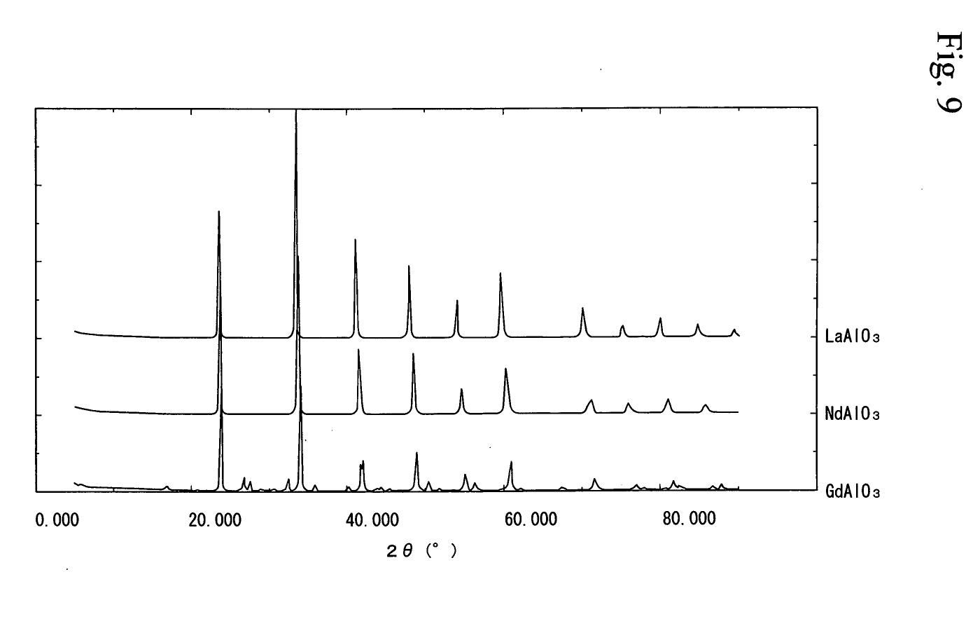

Thus, it was proven that purification characteristics of the purification catalysts for exhaust gas of Production Examples 1 and 2 which are within the range of the present invention were superior to that of purification catalysts for exhaust gas of Production Examples 3 and 4 which are outside the range of the present invention; however, in order to prove this result, evaluation of Pd dispersion degree was further carried out. Specifically, each purification catalyst for exhaust gas of Production Examples 1 and 4 was measured by a CO adsorption method at a gas temperature of 50° C. That is, before measuring an absorbed amount of CO, each purification catalyst for exhaust gas was exposed to O₂ at 400° C. for 15 minutes and at H₂ 400° C. for 15 minutes using a CO pulse method and the measured temperature was raised to 50° C. Here, the Pd amount was set to 0.75 g/L. The results are shown in FIG. 6

As is apparent from FIG. 6, in the purification catalysts for exhaust gas of Production Examples 1 and 2 which are within the range of the present invention, it was shown that the Pd dispersion degree was higher than that of the purification catalysts for exhaust gas of Production Examples 3 and 4 which are outside the range of the present invention and exceeded about 10%. In FIG. 6, the Pd dispersion degree of the purification catalyst for exhaust gas of Production Example 3 was remarkably low, since this purification catalyst for exhaust gas consisted of a mixture of PdO and alumina and positions where Pd did not exist at all were partially formed. In addition, in FIG. 6, Pd dispersion degree of the purification catalyst for exhaust gas of Production Example 4 was lower than those of the purification catalysts for exhaust gas of Production Examples 1 and 2, since in a producing process, mixing aqueous solution of. palladium nitrate and lanthanum nitrate was neutralized by ammonium carbonate and concentrated so as to obtain a mixture in a paste state, and Sr₂PdO₃ powder was thereby produced, and a process for adding malic acid, etc., to nitrate aqueous solution, which are suitable production processes for the present invention, were not included.

### 2. Second Embodiment

### Production Example 5

Production of Composite Oxides as Supporting Material

Predetermined amounts of lanthanum nitrate hexahydrate and aluminum nitrate nonahydrate were dissolved in ion-exchanged water, whereby a mixed solution was obtained. Next, a predetermined amount of malic acid was dissolved in ion-exchanged water, whereby an aqueous malic acid solution was obtained. These two solutions were mixed, the obtained mixed solution was set on a hot plate with a stirrer, and the mixed solution was heated to 250° C. and agitated by a stirring bar, whereby evaporation of water was performed, complete evaporation was performed, and the dried sample was crushed into a powder by a mortar and pestle. The crushed sample was moved to an aluminum crucible, the sample was heated to 350° C. at a rate of 2.5° C./min in a muffle furnace, and a heat treatment was performed at 350° C. for 3 hours. Due to the heat treatment, a provisional fired substance in which malate and nitrate-nitrogen (nitrate salt and nitrate ion) were removed was obtained. After crushing the provisional fired substance into powder and mixing for 15 minutes by a mortar and pestle, the obtained mixture was set in the aluminum crucible again, the sample was heated to 800° C. at a rate of 5° C./min in the muffle furnace, and a heat treatment was performed at 800° C. for 10 hours. Due to the heat treatment, a perovskite-like composite oxide of which the composition was LaAlO₃ was obtained.

Supporting of Pd-based Composite Oxide

A metal salt mixed aqueous solution was prepared by dissolving predetermined amounts of palladium nitrate dehydrate and strontium nitrate hexahydrate in ion-exchanged water. An aqueous solution of malic acid was prepared by dissolving a predetermined amount of malic acid in ion-exchanged water. These two aqueous solutions were mixed, and this mixture and a predetermined amount of LaAlO₃ powder were put in an eggplant-shaped flask, and while evacuating the flask by a rotary evaporator, the mixture was evaporated and solidified in a hot bath at 60° C. By heating to 250° C. at a rate of 2.5° C./min in a muffle kiln, the temperature was further raised to 750° C. at a rate of 5° C./min, and was held at 750° C. for 3 hours. As a result, a catalyst powder of Production Example 5 of Sr₂PdO₃/LaAlO₃ having Sr₂PdO₃ impregnated and supported on LaAlO₃ was obtained.

Evaluation of Activity

Next, initial activities and activities after endurance running were evaluated for the obtained catalyst powder of Production Example 5. The evaluation was performed by flowing model exhaust gas of an automobile into catalysts under conditions in which the A/F (air-fuel ratio) was substantially 14.6 and SV (stroke volume) was 5000 h⁻¹. Endurance running was performed for 20 hours at an endurance running temperature of 980° C. by using model exhaust gas in which A/F (air-fuel ratio) was substantially 14.6. These results are shown in Tables 4 and 5. That is, Table 4 shows 50% purification temperature of CO, HC, and NO in a temperature raising test of catalysts before the endurance running. Moreover, Table 5 shows 50% purification temperature of CO, HC, and NO in a temperature raising test of catalysts after the endurance running.

TABLE 4

| | | 50% Purification Temperature (° C.) | | |
|---|---|---|---|---|
| | | CO | HC | NO |
| Production | SrPdO₃/LaAlO₃ | 249 | 278 | 172 |
| Example 5 | | | | |
| Production | Ba₂PdO₃/LaAlO₃ | 250 | 280 | 165 |
| Example 6 | | | | |
| Production | Sr₂PdO₃/NdAlO₃ | 240 | 273 | 170 |
| Example 7 | | | | |
| Production | Pd/Al₂O₃ | 255 | 280 | 246 |
| Example 8 | | | | |
| Production | Pd/LaAlO₃ | 263 | 285 | 182 |
| Example 9 | | | | |
| Production | Sr₂PdO₃/GdAlO₃ | 267 | 297 | 198 |
| Example 10 | | | | |

TABLE 5

| | | 50% Purification Temperature (° C.) | | |
|---|---|---|---|---|
| | | CO | HC | NO |
| Production | Sr₂PdO₃/LaAlO₃ | 246 | 331 | 217 |
| Example 5 | | | | |
| Production | Ba₂PdO₃/LaAlO₃ | 259 | 318 | 212 |
| Example 6 | | | | |
| Production | Sr₂PdO₃/NdAlO₃ | 259 | 328 | 215 |
| Example 7 | | | | |
| Production | Pd/Al₂O₃ | 273 | 315 | 270 |
| Example 8 | | | | |
| Production | Pd/LaAlO₃ | 333 | 351 | 236 |
| Example 9 | | | | |
| Production | Sr₂PdO₃/GdAlO₃ | 295 | 360 | 250 |
| Example 10 | | | | |

### Production Example 6

In the same manner as in Production Example 5, Ba₂PdO₃/LaAlO₃ was produced, and various evaluations for activity were performed. The results are shown in Tables 4 and 5.

### Production Example 7

In the same manner as in Production Example 5, Sr₂PdO₃/LaAlO₃ was produced, and various evaluations for activity were performed. The results are shown in Tables 4 and 5.

### Production Example 8

In the same manner as in Production Example 5, Pd/Al₂O₃ was produced, and various evaluations for activity were performed. The results are shown in Tables 4 and 5.

### Production Example 9

Predetermined amounts of lanthanum oxide and aluminum oxide were mixed by mortar and pestle, the mixed sample was moved to an aluminum crucible, the sample was heated for 10 hours at 1100° C. in a muffle kiln, and LaAlO₃ was obtained by solid-phase reaction. Using this, Pd was supported in the same manner as in Production Example 5, and Pd/LaAlO₃ was produced. Various evaluations for activity were performed for this catalyst. The results are shown in Tables 4 and 5.

### Production Example 10

In the same manner as in Producing Example 5, Sr₂PdO₃/GdAlO₃ was produced, and various evaluations for activity were performed. The results are shown in Tables 4 and 5.

According to Tables 4 and 5, the purification catalysts for exhaust gas of the Production Examples 5 to 7 exhibit excellent 50% purification temperatures of CO, HC, and NO at any time before and after the endurance running. The reason for this is that the purification catalysts for exhaust gas of the Production Examples 5 to 7 are made by supporting Pd-based composite oxide which is a composition of A₂AlO₃ (A: alkaline earth material) on Al oxide and these catalysts have a property of suppressing a reduction of Pd-based composite oxide to Pd at high temperatures, whereby the high activity can be maintained in the running at low temperatures after a running at high catalyst temperatures. In addition, in the purification catalysts for exhaust gas in Production Examples 5 to 7, the crystal system of Al oxides is trigonal or rhombohedral form, and the B site of perovskite is Al, and hence the electron instability is great. Hence, Pd-based composite oxide adjacent to LaAlO₃ or NdAlO₃ is greater in electron fluctuation than in an independent Pd-based composite oxide. Furthermore, in the purification catalysts for exhaust gas in Production Examples 5 to 7, when producing of LaAlO₃ or NdAlO₃, by a process of once obtaining carboxylic complex polymer by evaporating and solidifying the aqueous solution of nitrate of constituent elements containing carboxylic acid, LaAlO₃ or NdAlO₃ is produced in a single phase, and when supporting Pd-based composite oxide, the surface state is likely to interact with the Pd-based composite oxide. In the process of producing the mixed aqueous solution, malic acid is used; however, the same effects are obtained by using citric acid or oxalic acid.

In contrast, in the purification catalysts for exhaust gas in Production Examples 8 to 10, sufficient performance cannot be obtained in low temperature operation as compared with the purification catalysts for exhaust gas in Production Examples 5 to 7, and the reason is as follows. In Production Example 8, Al₂O₃ is a stable compound, and it does not interact with the supported noble metal Pd, and the Pd itself is not enhanced in activity. In the purification catalyst for exhaust gas in Production Example 9, although the crystal system of Al oxide is trigonal or rhombohedral form, since carboxylic acid is not used in the production process of catalyst, LaAlO₃ of single phase cannot be synthesized. Hence, sufficient specific surface area is not obtained, and the crystal lattice surface cannot be used in an active state. In the purification catalyst for exhaust gas in Production Example 10, the crystal system of Al oxide is orthorhombic, and the electrons among component atoms is not as unstable as in the trigonal or rhombohedral form.

1. A purification catalyst for exhaust gas comprising Pd-based composite oxide containing at least one element selected from alkaline earth metals.

2. The purification catalyst for exhaust gas according to claim 1, wherein the Pd-based composite oxide contains A₂PdO₃ in which A is an alkaline earth metal.

3. The purification catalyst for exhaust gas according to claim 1, wherein the Pd-based composite oxide is produced by adding at least one compound selected from the group of compounds including carboxylic acid of carbon number 2 to 20 having a OH group or a SH group, dicarboxylic acid of carbon number 2 or 3, and monocarboxylic acid of carbon number 1 to 20 to an aqueous nitrate solution of the composite oxide.

4. The purification catalyst for exhaust gas according to claim 3, wherein the catalyst is produced by a process for preparing carboxylic acid complex polymer by evaporating and drying the aqueous nitrate solution and a process for firing the carboxylic acid complex polymer.

5. A production method for the purification catalyst for exhaust gas comprising Pd-based composite oxide containing at least one element selected from alkaline earth metals, the method comprising:
adding at least one compound selected from the group of compounds including carboxylic acid of carbon number 2 to 20 having a OH group and a SH group, dicarboxylic acid of carbon number 2 or 3, and monocarboxylic acid of carbon number 1 to 20 to an aqueous nitrate solution of the composite oxide.

6. The production method of the purification catalyst for exhaust gas according to claim 5, wherein the method comprises:
preparing a carboxylic acid complex polymer by evaporating and drying the aqueous nitrate solution; and
firing the carboxylic acid complex polymer.

7. The production method of the purification catalyst for exhaust gas according to claim 6, wherein the firing temperature is not more than 900° C.

8. A purification catalyst device for exhaust gas for automobiles comprising Pd-based composite oxide containing at least one element selected from alkaline earth metals, wherein the Pd-based composite oxide purifies exhaust gas from automobiles.

9. A purification catalyst for exhaust gas, comprising an Al oxide supporting a Pd oxide, wherein the Pd oxide is A₂PdO₃ in which A is an alkaline earth element.

10. The purification catalyst for exhaust gas according to claim 9, wherein the Al oxide is LnAlO₃ in which Ln is a rare earth element.

11. The purification catalyst for exhaust gas according to claim 10, wherein a crystal system of the Al oxide is trigonal or rhombohedral form.

12. The purification catalyst for exhaust gas of claim 10, wherein the catalyst is produced by adding at least one kind of compound selected from the group of compounds of carboxylic acid having a hydroxyl group or a mercapto group and having a carbon number of 2 to 20, dicarboxylic acid having a carbon number of 2 or 3, and monocarboxylic acid having a carbon number of 1 to 20 to an aqueous nitrate solution the composite oxide.

13. The purification catalyst for exhaust gas according to claim 12, wherein the catalyst is produced by evaporating the aqueous nitrate solution completely, to produce a carboxylic acid complex polymer and by firing the carboxylic acid complex polymer.

14. A production method for a purification catalyst for exhaust gas, the method comprising:
preparing at least one kind of compound selected from a group of compounds of carboxylic acid having a hydroxyl group or a mercapto group and having a carbon number of 2 to 20, dicarboxylic acid having a carbon number of 2 or 3, and monocarboxylic acid having a carbon number of 1 to 20; and
adding at least one compound selected from the group to an aqueous nitrate solution the composite oxide.

15. The production method for a purification catalyst for exhaust gas according to claim 14, the method comprising:
evaporating aqueous carboxylic acid completely to produce a carboxylic acid complex polymer; and
firing the carboxylic acid complex polymer.

16. The production method for a purification catalyst for exhaust gas according to claim 14, wherein a firing temperature in firing the carboxylic acid complex polymer is not more than 1000° C.

17. A purification catalyst apparatus for automobile exhaust gas having Pd oxide supported on Al oxide for purifying exhaust gas emitted from an automobile, wherein the Pd oxide is A₂PdO₃ in which A is an alkaline earth element.
